(19) United States
(12) Patent Application Publication
(10) Pub. No.: US 2013/0188017 A1
(43) Pub. Date: Jul. 25, 2013

(54) Instant Calibration of Multi-Sensor 3D Motion Capture System

(71) Applicant: Chris Chen-Hsing Ma, Vancouver (CA)

(72) Inventor: Chris Chen-Hsing Ma, Vancouver (CA)

(73) Assignee: Chris Chen-Hsing Ma, Vancouver, BC (CA)

(21) Appl. No.: 13/356,808

(22) Filed: Jan. 24, 2012

(51) Int. Cl. H04N 13/02

(52) U.S. Cl. 348/46; 348/E05.024

(57) ABSTRACT

A method for instantly determining the mutual geometric positions and orientations between a plurality of 3D motion capture sensors has three or more reference markers mounted fixedly relative to each other on substantially one single plane which are sensed by each sensor. Said method enables said sensors to cooperate as a larger sensing system for 3D motion capture applications without requiring said sensors to be mounted rigidly relative to each other.

### BACKGROUND OF THE INVENTION

Optical 3D motion capture (“mocap”) systems have been in use for several decades. For example, to improve a rehabilitation procedure, a patient's motions must be captured for analysis and correlation with the results. To improve the performance of a sportsperson, his or her motions need to be compared with those of the champion in order to determine the differences. Games, cartoons and movies require lots of computer animation to produce, the motions seen in the animation can be acted out by actors, digitized by motion capture systems, then applied to drive otherwise motionless computer characters. Recently virtual reality has become a popular research topic because the technology can be applied for virtual training of pilots, surgeons, athletes and all kinds of special people. To achieve the training goal the training subject (“immersant”) must first be made to immerse in a virtual environment. The virtual environment must react to the motions of the immersant, and the immersant's motions can be sensed with a motion capture system.

A multi-sensor optical 3D motion capture system available today is made with either 2D sensing units or 3D sensing units (“sensors”). A system with 2D sensors requires at least two sensing units in order to sense 3D motions of an object. Such systems are being marketed by at least Vicon Motion Systems of UK, Motion Analysis Corporation and Phase Space Inc. of USA, and Qualisys AB of Sweden. A system with 3D sensors requires just one sensing unit to sense 3D motions. Such systems are being marketed by at least Northern Digital Inc. and Phoenix Technologies Inc. of Canada.

Previously, when a 3D motion capture system consists of two or more sensors, the relative positions and orientations between said sensors must be precisely known in order for the system to fuse the multiple sets of data produced by the sensors into a single set representing the unique motions of the object being captured. The process of finding out said relative positions and orientations is referred to as multi-sensor system calibration (“system calibration”). This process invariably requires said sensors to simultaneously collect corresponding position data of markers defining a plurality of points in 3D space. Until recently every optical motion capture system in the market has resorted to using a rigid tool (“calibration tool”) to carry the markers and requiring the user to manually wave it over the intended capture space in 3D to collect said corresponding position data (“calibration data”). For a system made with 2D sensors, the relative positions between said markers must be precisely known, hence a rigid precision tool is required to carry the markers. Said marker data must also be spread over a 3D space, hence said precision tool must be at least 2D in construction. To calibrate such a system accurately requires the user to understand somewhat how calibration is accomplished and how the tool should be waved to collect the necessary data. For a system composed of 3D sensors, said tool can be simpler in construction, such as a stick, and carries fewer markers. However, it still requires the user to understand, though in lesser degree, how calibration is accomplished and how the simpler calibration data must be collected. This procedure must be repeated every time when a sensor is or suspected to have been moved relative to the other sensors.

In 2006, Phoenix Technologies Inc. of Canada (“PTI”) improved its 3D sensor system calibration process by making use of the marker data captured during a motion capture session. This eliminated the need to collect calibration data in a separate manual procedure and the need to have a calibration tool, thus making its Visualeyez system the first optical 3D motion capture system with fully automatic system calibration capability. Moreover, PTI programmed its system to continuously update the calibration data, thus made the system calibration adaptive (“adaptive calibration”) to sensor movements and setup changes due to factors such as temperature variation.

Nevertheless the PTI adaptive calibration capability still requires the system to collect a large amount of marker data before the system can be calibrated to high enough accuracy. This makes the system calibration tolerant of slow setup changes only, such as those due to slow room temperature variations. In case the system setup suffered a sudden change, the system may yield inaccurate motion capture data for a significant duration during and after the change. If the setup experiences a continuous movement, the system may even stay inaccurate for as long as the movement last. This makes said automatic adaptive calibration capability still not good enough for situations in which the sensors may keep moving during a motion capture session, such as when they are mounted on a flexible structure or on a moving platform.

It is obvious that one way to make every captured motion data set (“mocap data”) accurate is to keep the system calibrated at all times. This means that in case the system setup suffers a sudden change, the system must recover its accurate calibration instantly, with just one new set of motion data captured after the change if possible.

The present invention not only eliminates the need for the user to manually collect calibration data in a separate procedure, but also enables a multi-sensor optical 3D motion capture system composed of 3D sensors to be calibrated instantly while the sensors may be in constant random motion.

### SUMMARY OF THE INVENTION

The present invention provides a method for instantly calibrating a multi-sensor optical 3D motion capture system composed of 3D sensors. Said method consists three or more reference markers and an algorithm. The reference markers are attached rigidly relative to the motion capture data coordinate reference frame (“world CRF”, or “WCRF”), are arranged such that at least three are seen by each sensor of the system substantially at all times, and are pre-calibrated such that their relative positions to each other are precisely known. The algorithm inverts the matrix of reference marker data in the WCRF, multiplies the inverse with the matrix of reference marker data obtained by a sensor in that sensor's local coordinate reference frame (“sensor CRF”, or “SCRF”), and directly uses the product to compute positions of the motion capture markers seen by that sensor in the WCRF, while said sensor may be moving randomly. In one exemplary embodiment of the method which avoids introducing obstruction to the motion capture space, all reference markers are located substantially on one plane (such as the floor), the algorithm artificially adds at least one cross-product of the reference marker data to make the matrix invertible, and computes the motion capture marker positions.

The invention further provides a method for automatically pre-calibrating the relative positions of the reference markers by using the 3D sensors of the system itself without purposefully manipulating any of them. Said method consists arranging the three or more reference markers attached rigidly to the WCRF such that at least three are seen by each sensor of the system substantially at all times, and at least three seen by a first sensor of the system are also seen by at least one second sensor of the system. At least three reference markers seen by a second sensor of the system are also seen by at least one third sensor of the system, and so on, such that at least three reference markers seen by a last sensor of the system are also seen by at least one second last sensor of the system.

### DESCRIPTION OF THE SEVERAL VIEWS OF THE DRAWING

FIG. 1 This drawing illustrates a general embodiment of the present invention. S1, Sd, Se denote three of possibly many more 3D sensors of a multi-sensor motion capture system. The r(.)'s denote reference markers located within the motion capture space fixed relative to the motion capture data coordinate reference frame.

FIG. 2 This drawing illustrates an example preferred embodiment of the present invention with all reference markers located on the floor to avoid obstructing the use of a motion capture space.

FIG. 3 This drawing illustrates an example reference marker arrangement condition under which an embodiment of the present invention can calibrate said reference marker positions instantly autonomously.

### DETAILED DESCRIPTION OF THE INVENTION

### Prior Art

To the best knowledge of this inventor, there is no prior art relating to instant calibration of a multi-sensor optical 3D motion capture system, whether the system is made of 2D sensors or 3D sensors. The closest technology for multi-sensor optical 3D motion capture system calibration, developed by Phoenix Technologies Inc. of Canada for their Visualeyez system, is only capable of automatic calibration which requires the use of numerous previous sensed data and hence cannot achieve instant calibration or tolerate continuous sensor motions. All other known multi-sensor optical 3D motion capture systems require the user to manually help the system collect a vast amount of data for calibration, which means they cannot tolerate any sensor movement at all during the entire motion capture session. Any sensor movement during a motion capture session will make the system lose accuracy and require another manual calibration procedure before accurate motion capture can resume.

### The Invention—Introduction

A fundamental object of the invention is to provide a method for instantly calibrating a multi-sensor optical 3D motion capture system so that the system may tolerate some possible constant random sensor movements during a motion capture (“mocap”) session without losing accuracy. Another object of the invention is to achieve the instant calibration capability without introducing obstruction into the motion capture space (“mocap space”).

Below first describes a general method for achieving the instant calibration object of the invention. However this general method requires the use of at least four reference markers which must be located in a 3D pattern and fixed relative to the motion capture space. This would introduce obstruction to a typical mocap space which is normally simply an empty space over a flat floor on which the motion capture subject(s) (“mocap subject”) or actors act out their motions. To eliminate the possible obstruction, a preferred embodiment of the invention is further described subsequently.

### General Embodiment with Pre-Calibrated Reference Markers

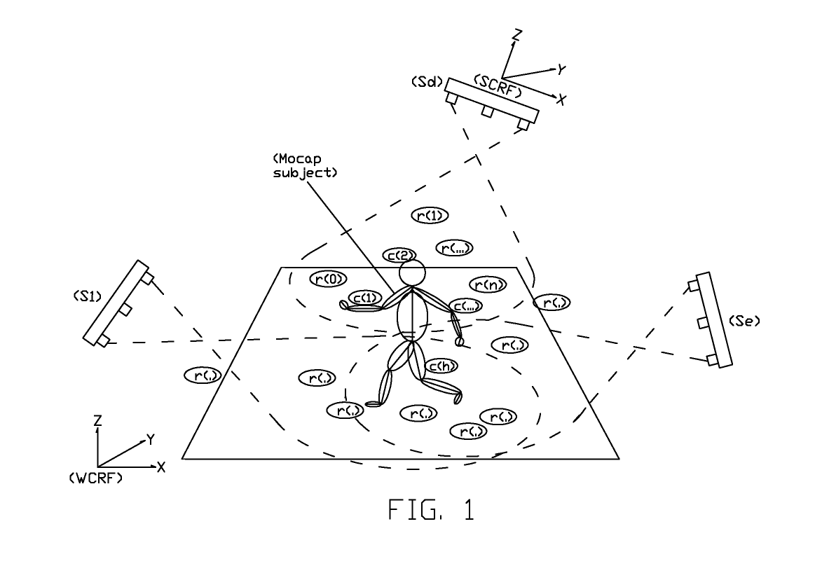

FIG. 1 illustrates a general embodiment of the present invention. S1, Sd, Se denote three of the possibly many more 3D sensors of a multi-sensor optical 3D motion capture system. The numerous r(.)'s denote reference markers located within the motion capture space fixed relative to the motion capture data coordinate reference frame WCRF. It is assumed that sensor Sd is able to sense n+1 of the reference markers r(0), r(1), . . . , r(n) and h motion capture markers (“mocap markers”) c(1), c(2), . . . , c(h) on the mocap subject at time t.

Let p(0w), p(1w), . . . , p(nw) denote the 3×1 position vectors (“positions”) of the reference markers r(0), r(1), . . . , r(n) in the WCRF (“world positions”). It is assumed in this embodiment of the invention that they are accurately known by a pre-calibration procedure. Let p(0s,t), p(1s,t), . . . , p(ns,t) denote the positions of the same reference markers as sensed by sensor Sd at time t in the sensor's local coordinate reference frame SCRF (“local positions”). Then it is well-known that there exists a 4×4 transformation matrix, denote by T(ws,t), such that

$$\begin{matrix} T ( ws , t ) [ \begin{matrix}p ( iw ) \\ 1\end{matrix} ] = [ \begin{matrix}p ( is , t ) \\ 1\end{matrix} ] , for i = 0 , 1 , … , n , & ( 1 ) \\ T ( ws , t ) [ \begin{matrix}p ( 0 w ) & p ( 1 w ) & … & p ( nw ) \\ 1 & 1 & … & 1\end{matrix} ] = [ \begin{matrix}p ( 0 s , t ) & p ( 1 s , t ) & … & p ( n s , t ) \\ 1 & 1 & … & 1\end{matrix} ] , & ( 2 )\end{matrix}$$

r(0), r(1), . . . , r(n):=reference markers seen by sensor Sd,
c(1), c(2), . . . , c(h):=motion capture markers seen by sensor Sd,
   where T(ws,t) is composed of a 3×3 matrix representing rotation between the WCRF and the SCRF at time t, denote it by R(ws,t), and a 3×1 vector representing position offset between origins of the WCRF and SCRF at time t, denote it by O(ws,t), in the format

$$T ( ws , t ) = [ \begin{matrix}R ( ws , t ) & O ( ws , t ) \\ 0 & 1\end{matrix} ] , \qquad ( 3 )$$

R(ws,t):=3×3 rotation matrix between WCRF and SCRF at time t,
O(ws,t):=3×1 position offset between origins of the WCRF and SCRF at time t.

Similarly, let p(c1w,t), p(c2w,t), . . . , p(chw,t) denote positions of the h mocap markers c(1), c(2), . . . , c(h) on the mocap subject at time t in the WCRF. Let p(c1s,t), p(c2s,t), . . . , p(chs,t) denote positions of the mocap markers at time t as sensed directly by the sensor in the SCRF. Then

$$T ( ws , t ) [ \begin{matrix}p ( c 1 w , t ) & p ( c 2 w , t ) & … & p ( chw , t ) \\ 1 & 1 & … & 1\end{matrix} ] = [ \begin{matrix}p ( c 1 s , t ) & p ( c 2 s , t ) & … & p ( chs , t ) \\ 1 & 1 & … & 1\end{matrix} ] , \qquad ( 2 )$$

Note that if T(ws,t) can be derived, then the mocap marker positions, p(c1w,t), p(c2w,t), . . . , p(chw,t can be computed, which is the fundamental objective of every motion capture system in the market.

To derive the transformation matrix T(ws,t) we must first derive the rotation matrix R(ws,t) and the offset vector O(ws,t). To do this, first substitute (3) into (1) to get

R(ws,t)p(iw)+O(ws,t)=p(is,t) (5)

for i=0, 1, . . . n.
Subtracting (5) for one value of the variable i from the same with another value of i results in

R(ws,t)(p(iw)−p(jw))=(p(is,t)−p(js,t))

i, j=any of 0, 1, . . . , n, and

R(ws,t)[p(0w)−p(j(0)w) . . . p(nw)−p(j(n)w)]=[p(0s,t)−p(j(0)s,t) . . . p(ns,t)−p(j(n)s,t)] (6)

j(.)=any one of 0, 1, . . . , n, and each needs not be distinct.

Denote the large matrices as

P(/jw):=[p(0w)−p(j(0)w) . . . p(nw)−p(j(n)w)],

P(/js,t):=[p(0s,t)−p(j(0)s,t) . . . p(ns,t)−p(j(n)s,t)],

j(.)=any one of 0, 1, . . . , n,
then (6) can be simply expressed as

R(ws,t)P(/jw)=P(/js,t) (7)

From (7) it is obvious that if P(/jw) is full-rank, 3, then it can be inverted for computing R(ws,t) as

R(ws,t)=P(/js,t)P(/jw)′(P(/jw)P(/jw)′)⁻¹ (8)

and from (5) O(ws,t) can be computed as

O(ws,t)=p(is,t)−R(ws,t)p(iw) (9)

for i=any one of 0, 1, . . . , n.
With T(ws,t) computable according to (8), (9) and (3), note now that the ultimate purpose of a motion capture system is to obtain the h sensed motion capture marker positions in the WCRF, p(c1w,t), p(c2w,t), . . . , p(chw,t). Towards this end, note that (4) implies

R(ws,t)p(cgw,t)+O(ws,t)=p(cgs,t) (10)

for g=1, 2, . . . , h.
Plugging (9) into (10) yields

R(ws,t)(p(cgw,t)−p(iw))=p(cgs,t)−p(is,t),

and therefore

$$\begin{matrix}p ( cgw , t ) = {R ( ws , t )}^{- 1} ( p ( cgs , t ) - p ( is , t ) ) + p ( iw ) , \\ for g = 1 , 2 , … , h , i = any one of 0 , 1 , … , n , & ( 11 ) \\ = ( P ( \text{/} jw ) {P ( \text{/} jw )}^{′} ) {( P ( \text{/} js , t ) {P ( \text{/} jw )}^{′} )}^{- 1} ( ρ ( cgs , t ) - p ( is , t ) ) + p ( iw ) . & ( 12 )\end{matrix}$$

Note that all values on the right side of (12) are either known from a reference markers pre-calibration procedure or sensed by sensor Sd at time t only. Therefore this solution is equivalent to the sensor position and orientation relative to the WCRF having been calibrated instantly, hence insensitive to sensor movements. The full-rank requirement of P(/jw) can be satisfied easily if the number, n+1, of reference markers seen by the sensor is 4 or more (n≧3) and they are located in a 3D pattern.

### Preferred Embodiment with Reference Markers on a Plane

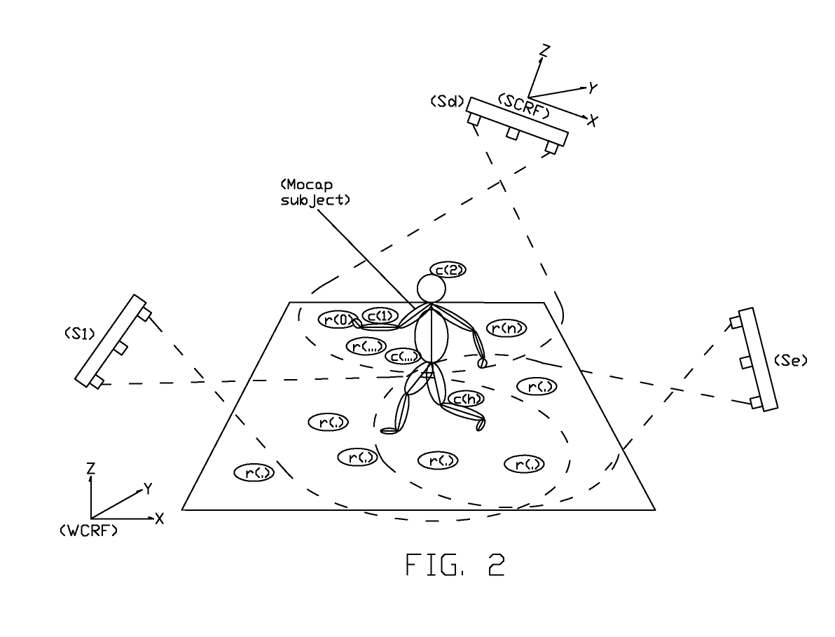

Having to locate the reference markers in a 3D pattern within the sensing space of a sensor means that at least some may protrude into the mocap space, unless they are all fixed at the edges of the capture space such as the bottom (“floor”), the top (“ceiling”), and/or the sides (“walls”). Markers placed far away from the mocap subject are generally inaccurate to sense, which is why the mocap subject does not make use of those places for acting in the first place. Therefore the ceiling and walls of a mocap space on earth are generally not good for locating the reference markers for instant system calibration purpose. Having some reference markers protruding into the middle of the mocap space is also not good since this would restrict utility of the space. This leaves only the floor a relatively acceptable and practical place for locating the reference markers for instant system calibration, as illustrated by FIG. 2.

Assuming as before that sensor Sd is able to sense n+1 of the reference markers r(0), r(1), . . . , r(n) and h motion capture markers c(1), c(2), . . . , c(h) on the mocap subject at time t, except that all n+1 reference markers are now fixed on the mocap floor as shown in FIG. 2. Since the floor is substantially a plane, the difference vectors p(iw)−p(j(i)w), . . . p(nw)−p(j(n)w) in P(/jw) of (7), which all lie in the plane, are linearly dependent on each other. Hence P(/jw) as defined in (7) cannot be full-rank and therefore is not invertible when the reference markers are all fixed on the floor.

To make P(/jw) full-rank, one way is to artificially introduce another vector which is neither on nor parallel to the same plane to P(/jw). A cross-product is guaranteed to be such a vector. Hence let's introduce at least one cross-product of two linearly independent members of the aforementioned difference vectors. This yields a new P(/jw) for this embodiment of the invention as

P(/jw):=[p(0w)−p(j(0)w) . . . p(nw)−p(j(n)w)(p(kw)−p(j(k)w))×(p(lw)−p(j(l)w))] (13)

Of course this means the corresponding cross-product(s) must also be artificially introduced to P(/js,t) in accordance to (6). This changes P(/js,t) for the case when all reference markers are on one plane to become

P(/js,t):=[p(0s,t)−p(j(0)s,t) . . . p(ns,t)−p(j(n)s,t)(p(ks,t)−p(j(k)s,t))×(p(ls,t)−p(j(l)s,t))] (14)

Since a cross-product of two vectors is perpendicular to both vectors, adding a cross-product is equivalent to having another reference marker fixed off the floor, except this one is non-physical and so not obstructive to a mocap session. This makes both P(/jw) and P(/js,t) full-rank. Hence R(ws,t) and O(ws,t) can again be formulated as (8), (9) respectively, and the h sensed motion capture marker positions in the WCRF can be computed as indicated by (12).

Now, note that since only three vectors are needed to make the three-row P(/jw) full-rank, P(/jw) only needs to contain two difference vectors and their cross-product to become full-rank. Therefore, only three or more (n≧2) reference markers fixed on the motion capture floor and visible to sensor Sd are required to instantly calibrate Sd so that it can help to capture the visible mocap marker positions accurately.

During a mocap session the mocap subject may occlude some of the reference markers. So depending on how and where they are installed on the floor, in practice more than three reference markers are likely required to make sure that at least three will be visible to a sensor at all times for instant calibration. For a multi-sensor system, even more reference markers should be installed in order for at least three to be sensed by each sensor at substantially all times for instant calibration of the entire system. On the other hand, in case more than three reference markers are visible to a sensor, the user may choose to make use of the position data of either just three of them for fast instant calibration, or all of them for higher calibration precision.

### Embodiment with Reference Marker Calibration

Both the general embodiment and preferred embodiment of this invention assumed that the reference marker positions in WCRF are known by a pre-calibration procedure. This procedure can be done with either a third-party 3D coordinate measurement machine (“CMM”) or the 3D sensors of the mocap system itself.

Note that once the reference marker positions in WCRF are known, there is no need for the mocap system sensor sensing spaces of the present invention to overlap to achieve system calibration. This is exceptional compared to all existing optical motion capture systems.

A CMM is generally meant for mechanically measuring the position of one spatial point at a time at very high accuracy. It is normally not available to a motion capture user, and may be quite difficult to measure the center position of a point light source with. An optical mocap system sensor is normally meant for measuring the positions of multiple markers over a large space at one time, so its accuracy is normally lower than that of a CMM. However a mocap system sensor is much easier to use for calibrating the reference marker positions with, since it is meant exactly for sensing the positions of such markers.

To calibrate the reference marker positions using the mocap system itself, the user can either manipulate one of the 3D sensors to make the measurements before reusing it as part of the mocap system, or simply arrange the reference markers such that the system sensors can calibrate their positions automatically. Besides autonomy, the latter solution would have the additional advantage of being able to tolerate slow changes of the reference marker positions too.

To be able to calibrate the reference marker positions autonomously, one way is to construct the system as follows:
C1. Define the WCRF with three fixed reference markers, for example r(000) at the origin, r(x00) somewhere along the +x axis, and r(xy0) somewhere on the +y half of the z=0 plane. If this is not good for a particular application, then r(000), r(x00) and r(xy0) can be markers placed temporarily for defining the WCRF before removal.
C2. Arrange the reference markers such that at least three will be seen by each sensor of the system substantially at all times during motion capture so that instant system calibration can be achieved as described in the previous embodiments.
C3. Further arrange the reference markers such that at least before the start of a mocap session at least three reference markers seen by a first sensor of the system are also seen by at least one second sensor of the system. At least three reference markers seen by a second sensor of the system are also seen by at least one third sensor of the system, and so on, such that at least three reference markers seen by a last sensor of the system are also seen by at least one second last sensor of the system. In other words, the sensors are linked together through sharing reference markers, and each link is at least three markers strong.

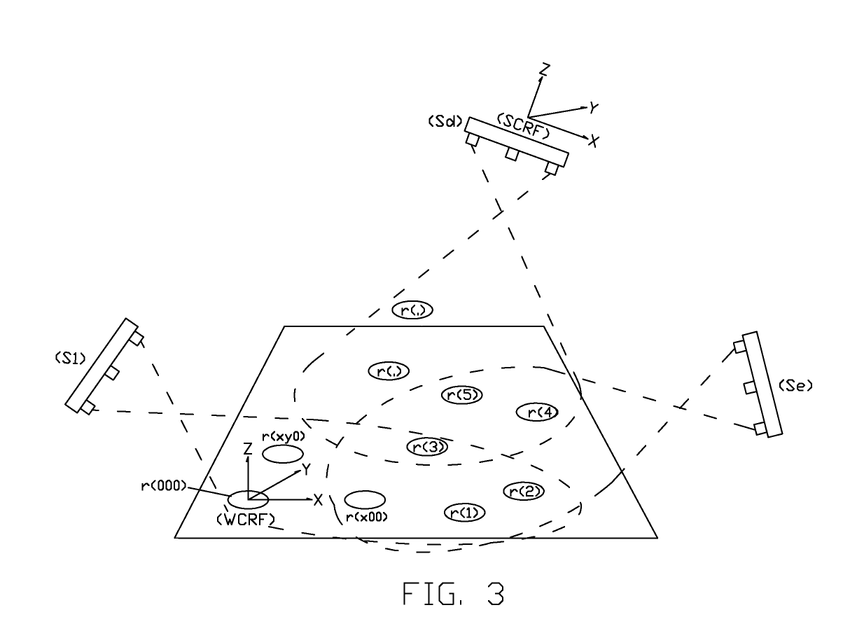

FIG. 3 illustrates a system constructed as above. Sensors S1, Se share reference markers r(x00), r(1), r(2), r(3), and sensors Se, Sd share reference markers r(3), r(4), r(5), so all three sensors of the system are linked together by sharing reference markers. The link between S1 and Se is four markers strong, while the link between Se and Sd is three reference markers strong.

To calibrate the reference marker positions, note first that since S1 can sense the distances between markers r(000), r(x00) and r(xy0) precisely, their world positions are immediately calibrated. Since the world positions of three reference markers are now available, the world positions of the other reference markers seen by S1, r(1), r(2), r(3) in FIG. 3 for example, can be computed according to the preferred embodiment of this invention. Since reference markers r(x00), r(1), r(2), r(3) are all seen by Se too, and their world positions are now available, the world positions of the other reference markers seen by Se, r(4), r(5) in FIG. 3, can also be computed now. Thus the process can continue with the other sensors and the extra reference markers that they see, until all reference marker world positions are precisely calibrated. This whole process should take just a fraction of a second. After this the mocap system becomes able to achieve instant calibration, and a motion capture session can start.

### Practical Issues

As indicated in equation (6), the subtrahends of the difference vectors in P(/jw) and P(/js,t) need not be distinct. To use the same subtrahend for all the difference vectors would actually make the algorithm easier to implement. However, since the magnitude of a difference vector does affect the accuracy of the inversion in (8), it may be desirable to use different subtrahends to compute the difference vectors in order to maximize accuracy of the inversion. In general, it is good for accuracy to make the magnitudes of all the difference vectors in P(/jw) and P(/js,t) roughly the same. This can be achieved by always using the farthest marker position to compute each difference vector.

During motion capture, a sensor may at times not be able to see even three reference markers. In that case the user can assume that R(ws,t) did not change, and compute the p(cgw,t) according to (12) using the p(is,t) and p(iw) of a visible reference marker.

Equation (12) indicates that the world position of a mocap marker can be computed using the world position p(iw) and local position p(is,t) of any of the visible reference markers. This means as many position values as the number of visible markers can be computed for each mocap marker at any time. By computing all of these values then averaging them can improve accuracy of the computed world position of each mocap marker.

As will be apparent to those skilled in the art in light of the foregoing disclosure, many alterations and modifications are possible in the practice of this invention without departing from the spirit or scope thereof. For example, three or more reference markers may be mounted on a light rigid structure such as a stick frame or a portable movie camera to define the WCRF for instant calibration purpose while a multi-sensor mocap system is carried by a truck to capture motions of subjects acting over an unconfined space with the planar WCRF defining structure hovering around the mocap subject. The reference markers may still be on a plane, but not on the floor of the mocap space in this case. Also the movement problems for which the instant calibration method of this invention was developed to overcome may not come only from the sensors, but instead may also come from movement of the WCRF defining structure itself. Accordingly, the scope of the invention is to be construed in accordance with the substance defined by the following claims.

What is claimed is:

1. A method for instantly calibrating a multi-sensor 3D motion capture system consisting 3D position sensors by independently determining the geometric position and orientation of each of said sensors relative to a global reference frame from a single set of data sensed during a motion capture session, comprising:
(a) a set of reference markers defining a plurality of reference points in 3D space representative of said global reference frame;
(b) an algorithm for computing said position and orientation of each of said sensors relative to said global reference frame from said single set of data;
wherein:
(i) said set of reference markers remain in operation throughout said motion capture session to provide said set of data; and,
(ii) said set of reference markers consists four or more reference marker units; and,
(iii) said reference marker units are displaced from one another in a 3D pattern and are further arranged such that at least four reference marker units can be sensed by each of said sensors at substantially any time;
(iv) said reference marker units are pre-calibrated, such that their positions relative to said global reference frame are precisely known;
(v) said algorithm computes said position and orientation from at least three position difference vectors between said at least four reference marker units sensed by each sensor.

2. A method as defined in claim 1, wherein:
(a) said set of reference markers consists three or more reference marker units; and,
(b) said reference marker units are arranged such that at least three reference marker units can be sensed by each of said sensors at substantially any time;
(c) said algorithm computes said position and orientation from at least two position difference vectors between said at least three reference marker units sensed by each sensor and a cross-product of said position difference vectors.

3. A method as defined in claim 2, wherein said set of reference markers are arranged in a plane.

4. A method as defined in claim 1, wherein said set of reference markers are calibrated relative to said global reference frame by the motion capture function of said 3D position sensors, wherein:
(a) one of said reference marker units sensed by a first of said sensors is defined as origin of said global reference frame; and,
(b) a second one of said reference marker units sensed by said first sensor is defined as being along one axis of said global reference frame; and,
(c) a third one of said reference marker units sensed by said first sensor is defined as being on a half plane bisected by said one axis;
(d) said set of reference markers are further arranged relative to said sensors such that at least three of said reference marker units sensed by said first sensor are also sensed by at least a second sensor, at least three of said reference marker units sensed by a said second sensor are also sensed by at least a third sensor, and so on, such that at least three of said reference marker units sensed by a second last sensor are also sensed by at least a last sensor.
